(19) United States
(12) Patent Application Publication
(10) Pub. No.: US 2005/0103754 A1
(43) Pub. Date: May 19, 2005

(54) Method of electron beam processing

(76) Inventor: Flemming Ove Olsen, Soro (DK)

Correspondence Address: Donald S Dowden;Cooper & Dunham, 1185 Avenue of the Americas, New York, NY, 10036, US

(21) Appl. No.: 10/504,379

(22) PCT Filed: Feb. 12, 2003
(86) PCT No.: PCT/DK03/00090

(30) Foreign Application Priority Data
Feb. 15, 2002 (DK) PA 2002 00230
Jul. 1, 2002 (DK) PA 2002 01025

(51) Int. Cl. B23K 15/10

(52) U.S. Cl. 219/121.14

(57) ABSTRACT

As a rule, electron beam welding takes place in a vacuum. However, this means that the workpieces in question have to be placed in a vacuum chamber and have to be removed therefrom after welding. This is time-consuming and a serious limitation of a process the greatest advantage of which is the option of welding workpieces of large thicknesses. Therefore the idea is to guide the electron beam (2) to the workpiece via a hollow wire, said wire thereby acting as a prolongation of the vacuum chamber (4) down to workpiece. Thus, a workpiece need not be placed inside the vacuum chamber, thereby exploiting the potential of electron beam processing to a greater degree than previously possible, for example by means of electron beam welding.

### TECHNICAL FIELD

The present invention relates to a method of beam processing, preferably electron beam processing such as electron beam welding of a workpiece positioned outside a vacuum chamber wherein the electron beam is generated.

### BACKGROUND ART

Electron beam welding can make very deep and narrow welds with minimum heat input to the workpieces to be welded. This results in welds with very little distortion.

As a rule, electron beam welding takes place in a vacuum. However, this means that the workpieces in question have to be placed in a vacuum chamber and have to be removed therefrom after welding. This is time-consuming and a serious limitation of a process the greatest advantage of which is the option of welding workpieces of large thicknesses.

Although devices have been developed for electron beam welding under atmospheric pressure, these devices are disadvantageous in that the electron beam collides with molecules in the air thereby scattering the beam quickly and the process losing its advantages.

### DISCLOSURE OF INVENTION

The object of the present invention is to provide a method of electron beam processing, especially electron beam welding at atmospheric pressure without the above-mentioned disadvantages.

According to the invention, a method of the type described in the preamble is characterized in that a wire is fed from the vacuum chamber to the workpiece arranged outside the vacuum chamber, and that the beam generated in the vacuum chamber is directed to the workpiece through the wire fed to the workpiece, said wire preferably being hollow. Thus, the beam can be transmitted down to the workpiece, provided that the vacuum chamber, the wire and the workpiece constantly form an unbroken chain. In this way the workpiece can be placed outside the vacuum chamber during electron beam processing.

Additionally, according to the invention, the wire can be fed from a magazine provided in the vacuum chamber.

Furthermore, according to the invention, a seal can be established around the wire where said wire exits the vacuum chamber.

According to the invention, the seal can be provided by reducing the diameter of the wire by means of pressing or pulling the wire through an output opening of a matrix.

The seal can also be provided without using reduction methods. Other options include e.g. common O-rings or piston rod seals or a combination thereof.

In a particularly preferred embodiment of the invention the wire can be formed using one or more flat wires, said wire or wires being fashioned into a tube inside the vacuum chamber.

Moreover, according to the invention, the advance path of the tube inside the vacuum chamber is curved, so that said tube is guided out of the vacuum chamber paraxially to the electron beam and substantially coaxially therewith, a hole being provided in the wire at the place where the wire crosses the path of the electron beam. This hole is relatively easy to provide and to “displace” together with displacing the wire.

### BRIEF DESCRIPTION OF THE DRAWINGS

The invention is described in greater detail below and with reference to the accompanying drawing, where

FIG. 1 shows an apparatus for electron beam processing using a well-known method,

FIG. 2 illustrates an inventive method of electron beam processing using a continuously advanced wire comprising two bands the cross-sections of which are semicircular, said bands being joined in the vacuum chamber by the electron beam,

FIG. 3 illustrates a method of electron beam processing using a continuously advanced wire, said wire being fashioned into a tube from a flat band inside the vacuum chamber,

FIG. 4 illustrates how a hollow wire is directed in front of the electron beam inside the vacuum chamber, whereupon the path of the wire curves and exits the vacuum chamber paraxially and substantially coaxially to the electron beam,

FIG. 5 shows an apparatus for sequential advance of wire pieces,

FIG. 6 shows the bottom part of the apparatus of FIG. 5 in a greater scale, where it is visible how the individual wire pieces are deformed prior to exiting the vacuum chamber,

FIG. 7 shows a nozzle arrangement at the place where the wire or wire pieces exit,

FIG. 8 shows a second embodiment of an apparatus for sequential advance of wire pieces, said apparatus being suitable for welding slightly larger gaps,

FIG. 9 shows one of several alternative ways to ensure optimum filling during welding as shown in FIG. 7 by preparing the parts to be welded,

FIG. 10 shows the use of a welding wire with an asymmetrically positioned hole,

FIGS. 11a and 11b show a third embodiment of an apparatus for sequential advance of wire pieces, where each wire piece is fed a filler material, either in the form of a powder or in the form of wire pieces with diameters smaller than the inside diameters of the sequentially advanced wire pieces, and where the first step of welding consists of melting the bottom of the primary wire piece, and the following steps including feeding of the powder or wire pieces,

FIG. 12 is an illustration of a method of cutting a workpiece by means of an electron beam, and

FIG. 13 is a graph of cutting speed vs. thickness.

### BEST MODE FOR CARRYING OUT THE INVENTION

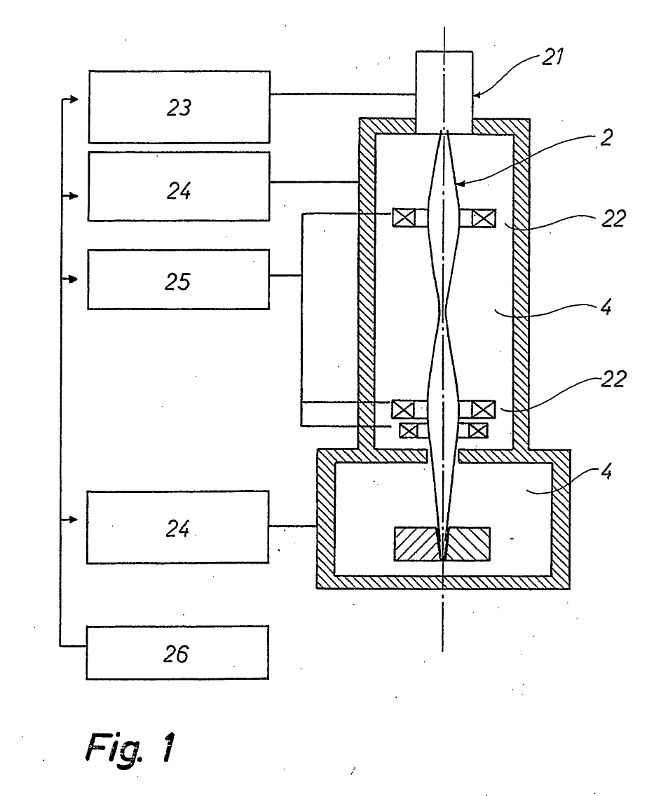

As a rule, electron beam processing takes place in a vacuum, for example by means of the apparatus shown in FIG. 1 comprising a vacuum chamber 4, wherein there is provided an electron beam gun 21. The electron beam 2 generated by the electron beam gun 21 is focussed by means of electromagnetic focussing coils 22 surrounding the electron beam 2 and is controlled by means of a beam focussing and deflection system. The focussed electron beam 2 is directed towards the workpieces to be welded, said workpieces being arranged in a lower part of the vacuum chamber 4. The electron beam gun 21 is connected to a high-voltage source 23, and the vacuum chamber is connected to a vacuum pump 24. The high-voltage source 23, the vacuum pumps 24 and the focussing and deflection system 25 are controlled by a common control system 26. The workpieces to be electron beam welded are placed in the vacuum chamber 4 and are removed therefrom after welding. This state of the art electron beam processing is therefore limited to workpieces with a maximum size predetermined by the size of the vacuum chamber 4. That is one of the greatest limitations of electron beam processing, the greatest advantage of which is that it is suitable for welding large thicknesses. Thus, the possible advantages of electron beam processing cannot be exploited fully with prior art methods.

Therefore the idea is to guide the electron beam from the vacuum chamber to a workpiece outside the vacuum chamber, via a preferably hollow welding wire, said welding wire thereby acting as a prolongation of the vacuum chamber down to workpiece. Thus, a workpiece can be placed outside the vacuum chamber, thereby avoiding the above-mentioned limitations posed by the state of the art.

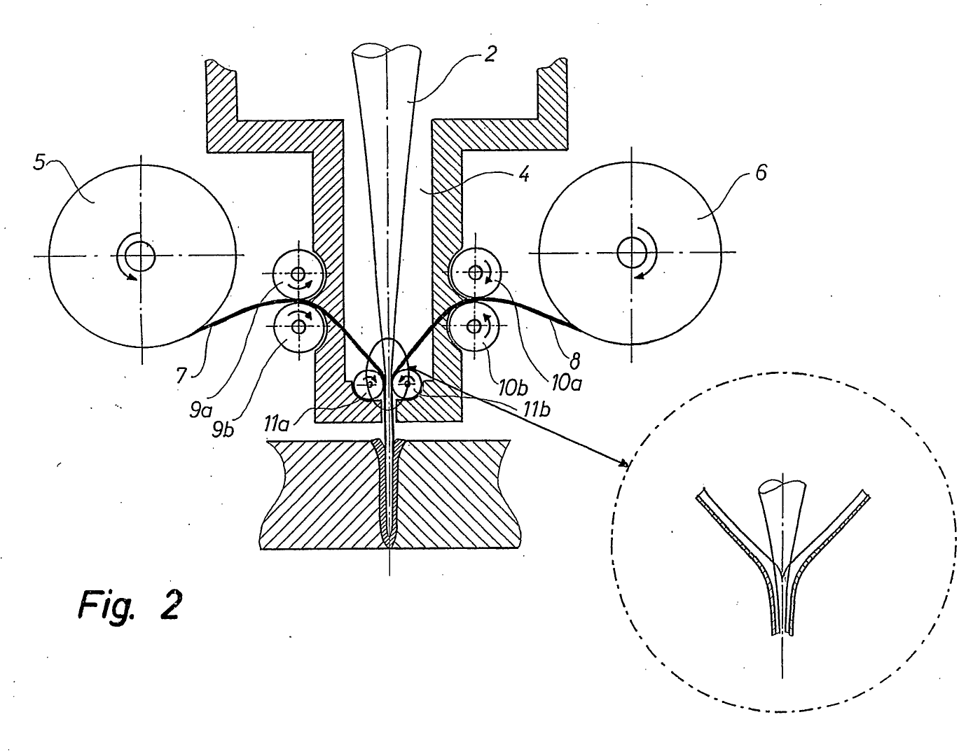

A first embodiment of the apparatus for carrying out the method according to the invention is shown in FIG. 2. The apparatus comprises a vacuum chamber 4 with an electron gun for generating the electron beam 2. A band 7 or 8 is fed into the vacuum chamber 4 from a roll 5 or 6 at different sides. The bands can be fashioned to form a wire by means of two sets of roller pairs, but the wire can also be formed prior to that. The latter results of course in certain problems caused by deformation of the wire when unwinding it from a roll and along the path to the welding point, but as the cross-section dimensions of the semicircular wires are relatively small, the above is possible, provided suitable care is taken in the design phase (not too small a curvature radius of the wire). If the bands are shaped by means of roller pairs 9a, 9b, 10a, 10b, their cross-section becomes semicircular, whereupon said bands are compressed and welded together inside the vacuum chamber by means of a roller pair 11a, 11b and the existing electron beam to form a wire in the shape of a tube, whereupon the tube-shaped wire is guided out of the vacuum chamber 4 and down to the processing place, where processing can be carried out by means of the electron beam 2 directed through the tube. Joining the two halves can be carried out by focussing the electron beam in such a way that a suitable (relatively small) portion of the outermost electron beam collides with the internal surface of the wire at the point of compression, thereby causing the two halves to weld together on the inside. Moreover, if care is taken during rolling (or prefabrication) of the wire parts that the finished wire will have a radius which is slightly reduced at the two edges, two goals are accomplished: On the one hand, the electron beam collides with the wire edges only in these two places, and on the other, wear on the seal at the exit point of the wire from the chamber is reduced.

It goes without saying that precautions have to be taken to ensure the necessary seal at the exit of the tube from the vacuum chamber 4 before it is guided down to the welding place. Such precautions are described below.

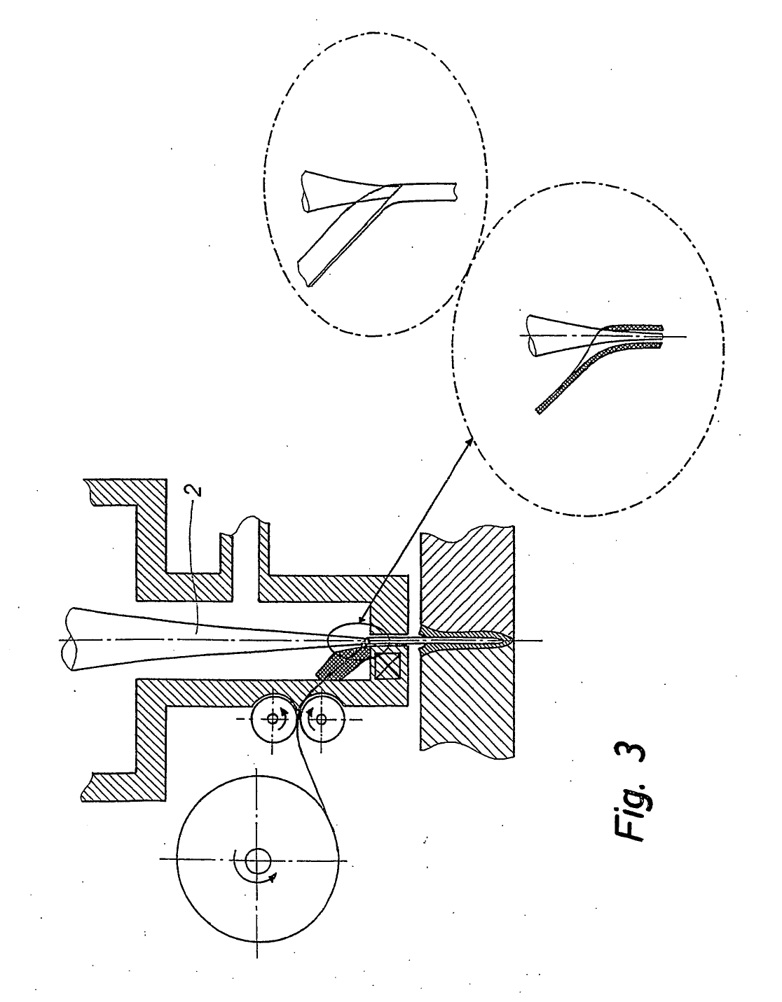

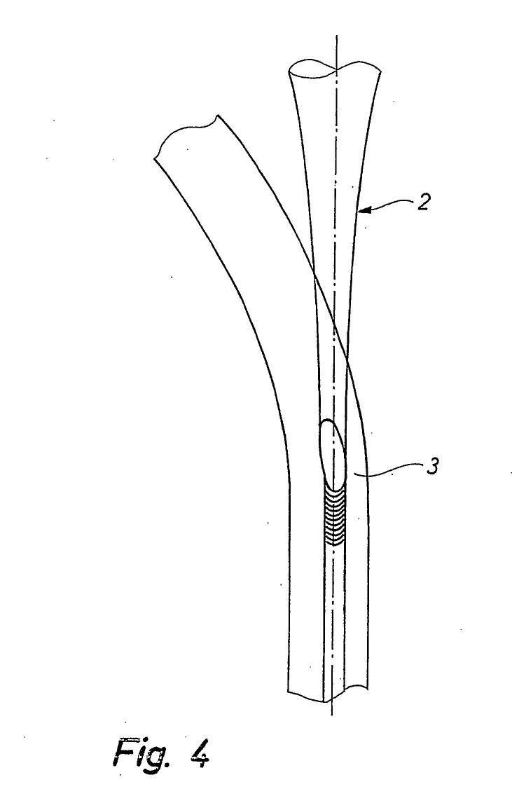

FIG. 3 shows an alternative embodiment where the tube is provided by a single band fashioned into a tube by deformation using a matrix. The seal can also be provided without reduction. It is, for example, possible to use ordinary O-rings or piston rod seals. Joining the adjacent edges of the band can e.g. be accomplished by means of the existing electron beam before it is directed through the hollow tube.

Alternatively, the wire can be manufactured by fashioning a flat band into a tube, winding the band in spiral form around the tube. Instead of using portions of the electron beam to weld the wire this method of manufacture permits the use of another welding source, such as a diode laser included inside the vacuum chamber, the beam of said diode laser colliding with the advancing wire.

Another alternative is the use of a prefabricated hollow wire, thus avoiding the deformation and joining processes. In this case, the hollow wire is guided in front of the electron beam 2 inside the vacuum chamber 4, whereupon the path of the wire curves so that it can be guided out of the vacuum chamber paraxially to the electron beam 2. Choosing suitable wire dimensions and advance speed of the wire the electron beam 2 drills a small hole 3 through the wire at exactly the point where the wire crosses the path of the electron beam. The technique described here is identical to keyhole welding characteristic of electron beam and laser welding, as this case is about keyhole welding where the larger portion of the beam passes straight through the keyhole. The melt surrounding the hole 3 moves downwards behind the electron beam 2 and seals the bottom section of the hole 3 (cf. FIG. 4) while the wire is being advanced, simultaneous with a second drilling being performed in the upper section of the hole 3. In other words, the hole 3 is displaced together with the wire. The size of the keyhole 3 is defined by the beam diameter, and is slightly smaller than the beam, typically being 0.3-1.0 mm depending on focussing which again is dependent on the welding depth as well as the adjustment and structure of the electron beam.

An alternative embodiment makes use of a continuously advanced solid wire. Like the hollow wire, the solid wire is guided in front of the electron beam 2 inside the vacuum chamber 4, whereupon the path of the wire curves so that it can be guided out of the vacuum chamber paraxially to the electron beam 2. Choosing suitable wire dimensions and advance speed of the wire the electron beam 2 drills a small hole 3 through the wire at exactly the point where the wire crosses the path of the electron beam. Also in this case, the melt surrounding the hole 3 moves downwards behind the electron beam 2 and again partially seals the hole 3 while the wire is being advanced. In this embodiment, the hole must be drilled all the way through the wire and down to the workpiece, and a larger portion of the electron beam's energy is therefore used to penetrate the wire.

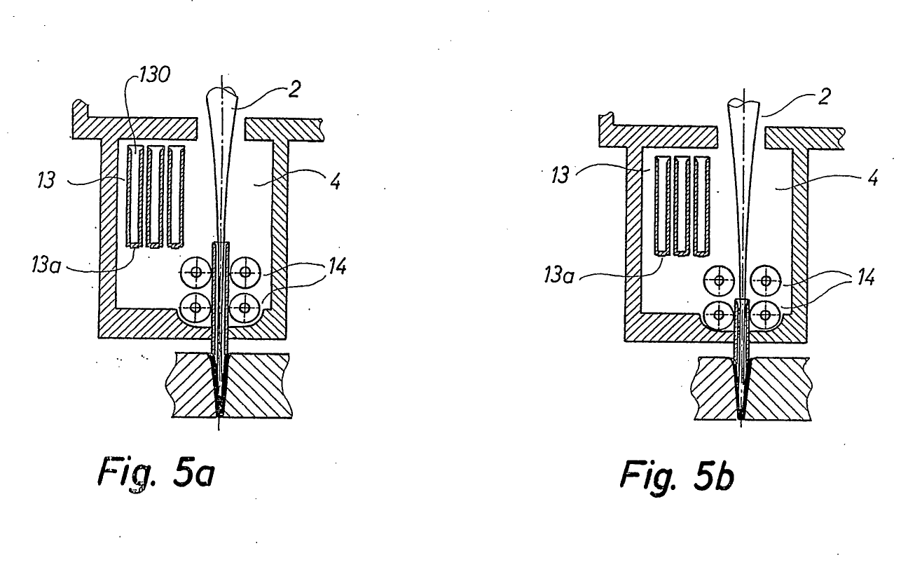

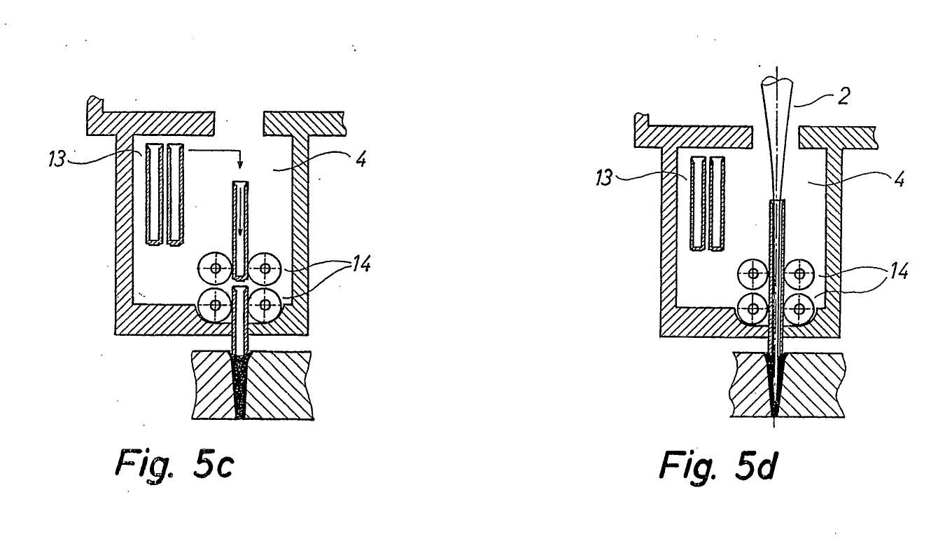

FIG. 5 shows an apparatus for electron beam processing by means of sequentially advanced tube pieces 13 stored in a magazine inside the vacuum chamber 4, wherefrom they are guided to an ejection system in the form of several clamp rollers 14 between which the tube pieces 13 are advanced, said guiding being performed by a gripping system (not shown). The tube pieces 13 are provided with a bottom 13a at one end, i.e. the lower end, and recesses 13b at one end or both ends. The recesses 13b ensure that the tube pieces 13 can be pushed into each other. The bottom 13a of each tube piece 13 is used to ensure that no gas reaches the vacuum chamber 4 during welding. In other words, the vacuum chamber 4 and its surroundings are substantially tightly sealed off from each other during almost the entire welding process. It goes without saying, however, that the welding process has to be stopped at regular intervals in order to refill the magazine in the vacuum chamber 4 with new tube pieces 13.

Depending on the selected type of wire, different means of advancing the wire can be used. The advance can e.g. be carried out by means of clamp rollers 14 as shown in FIG. 5, two rollers on each side of the wire or wire pieces or, in the case of sequentially advanced tube pieces, by means of a propelling mechanism (not shown), where the rear end of the top tube piece is being propelled. It goes without saying that in all these cases the advance speed must be adapted to prevailing conditions, but typically the speed is in the range of 1 mm per second. However, for certain types of processing the advance speed can be considerably higher.

Because of the focussing of the electron beam the distance for which the electron beam 2 is inside the wire must be kept at a minimum. At the same time, a certain wire length is required in order for the advance means to be able to transfer the necessary advance force to the wire.

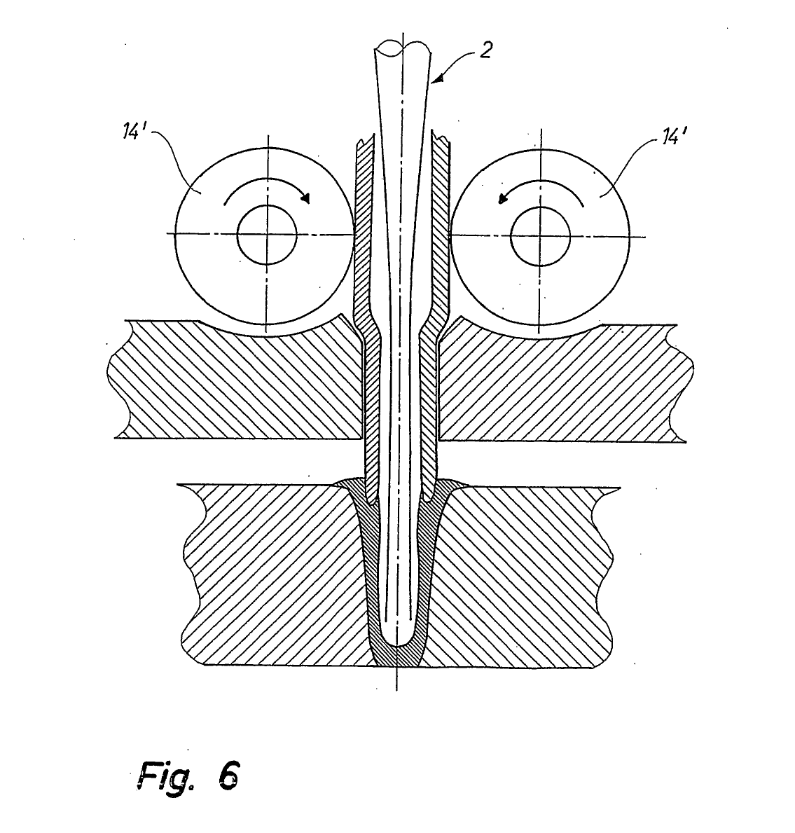

One method to minimize the air inflow into the vacuum chamber 4 through the wire exit point is to reduce the diameter of the wire by using the exit opening as a form of matrix, cf. FIG. 6. However, such a reduction of the wire diameter requires that a somewhat larger force is exerted upon the wire at the section where the electron beam 2 is paraxial to the wire. For continuous, but also for non-continuous advance of the wire this force can be provided by means of drive rollers 14′ positioned in this section.

Air inflow does not only occur during the passage of the wire to and from the vacuum chamber 4. It can also occur through gaps in the workpiece or workpieces to be machined, because of incomplete contact between wire and melt bath, because of a collapsed keyhole formed by the electron beam in the workpiece/workpieces as well as at start-up and stop.

A certain amount of leakage is permissible provided that there is also continuous evacuation.

However, air inflow along the wire must be kept to a minimum. In most cases the wire is joined inside the vacuum chamber 4 or pierced by electron beams 2 inside the vacuum chamber 4, so there is normally a weld or seam which may be the cause of air inflow.

A reduction of the wire after joining can reduce possible geometric errors and thus reduce air inflow. It is also possible to provide the exit opening with a seal through which the wire exits. In this case a stabilizer edge should be established above the seal as well as below the seal in order to take into account that the wire may be exposed to lateral forces during welding. A stabilizer edge is provided by adapting the hole through which the wire is guided to the outside diameter of the wire above and/or below the seal site so that said wire is closely controlled. The distance between the stabilizer surfaces should be as large as possible talking all other space requirements into account.

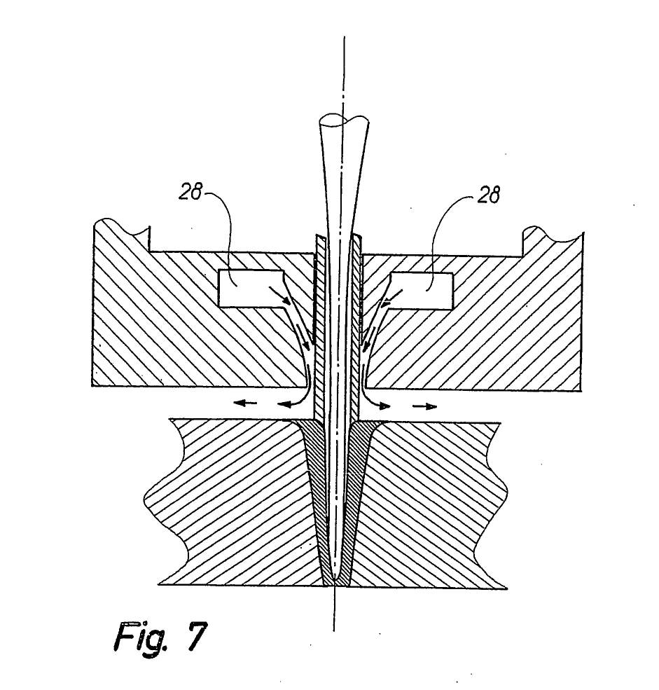

The air inflow may also be reduced by means of a nozzle arrangement 28 providing an injection effect around the wire, cf. FIG. 7.

One of the usual prerequisites of electron beam welding is a good fit between the workpieces to be welded prior to the actual welding. This results in considerably smaller deformations of the workpieces. In this respect the use of a filler wire opens up completely new possibilities, for example if it is desired to increase the width of the gap, although this may result in undesirable air inflow.

Another situation where there is a risk of air inflow arises in the case of a possible weld-through of the workpiece. In such a situation the electron beam generates an opening to the surrounding atmosphere at the bottom of the workpiece. Such a process can, however, be controlled automatically, since the air inflow reduces the penetration depth of the electron beam, and if the evacuation of the vacuum chamber is sufficiently hard the vacuum can be reestablished. It is also far from certain that hard evacuation is necessary. It is worthwhile to recall that pressure must be exerted from the inside of the melt in order to form/establish a keyhole. Said pressure is generated by the formation of vapor, therefore the keyhole is filled with metal vapor. When air molecules begin to flow into the keyhole from below upon weld-through at the bottom, said air molecules collide with the metal vapor, and these collisions result in a comparatively slow inflow of air molecules into the keyhole.

In certain cases it is also possible to control the process in such a way that although the keyhole does not pass through the workpiece, the melt will, as it expands slightly further than the keyhole.

In many cases the weld geometry can be shaped so that a complete weld-through of the workpiece or workpieces is not possible. A complete weld-through is not necessary either.

In order to avoid air inflow due to incomplete contact between wire the melt bath the wire must obviously have a certain minimum advance speed. If the advance speed is too high, the melt in the upper part of the weld may become unstable and the process stops. The advance speed can, if necessary, be controlled automatically, optionally by means of a feedback loop.

The process can be controlled by either an open or a closed loop. If open loop control is desired, it is advantageous to start with generating a database including each variation of the method according to the invention for controlling the wire advance and coordinated with the control of the traditional parameters for electron beam welding.

Closed loop control may be advantageous for certain applications, such as when the wire is fed to the surface.

Closed loop control is achieved by e.g.:

Measuring mechanical forces. If the wire penetrates to deeply, the resistance of the wire increases (the wire is advanced too quickly).

Pressure measurements in the vacuum chamber (in the section of an optionally multi-sectioned electron beam gun closest to the process and hence most pressure-sensitive) where possible gas inflow can be detected (the wire is advanced too slowly).

Online ultrasound detection continually detecting the position of the wire in the melt.

Online surface inspection by means of an optionally infrared camera monitoring the temperature on the surface of the melt. A drop in the surface temperature of the melt during welding is due to the fact that the wire is advanced too quickly and does not start melting until inside the workpiece, whereby the radial heat transmission to the melt surface is slowed down by the solid part of the wire.

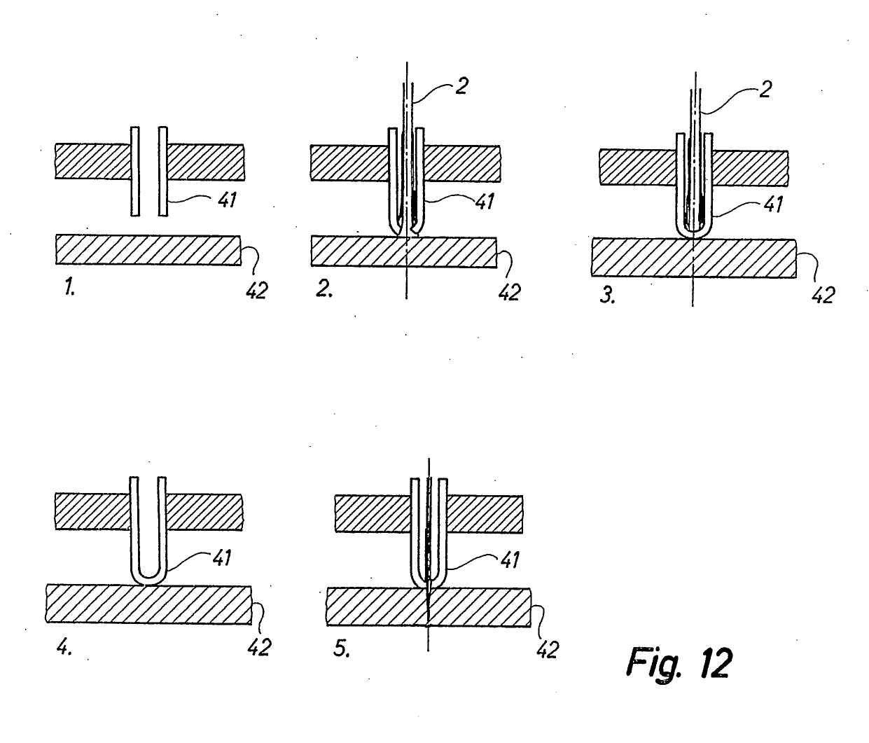

In the cyclic process illustrated in FIG. 12 the wire tip can be deformed (constricted), and a camera for visible light can monitor the wire shape online in order to control the process depending on this monitoring.

By continuously transmitting a known vibration to the wire an exact online measurement of the vibrations of the wire can determine the force and thus the attenuation that can be transmitted from the melt to the wire, said attenuation depending on the immersion depth of the wire in the melt.

The stability of the hole 3 in the wire depends on a local pressure balance, as the metal vapors from the melt try to keep the hole open while the surface tension of the melt as well as external forces try to close the hole, thus having the opposite effect.

One of the external forces capable of influencing electron beam processing is the weight of the melt. During vertical welding of very thick workpieces, for example, the gravitational force exerted upon the melt has a negative influence on the penetration depth. Correspondingly, atmospheric pressure on the top surface of the melt has a negative influence on the welding depth during processing.

In order to achieve optimum penetration into the workpiece the beam diameter as well as the outside diameter of the welding wire and the outside diameter of the melt have to be optimized.

Moreover, it has to be ensured at the end of the welding process that the end of the wire is closed, when the process is stopped. This can for example be achieved by using the electron beam 2 to seal the wire end at the end of the welding process so that the vacuum chamber 4 is not filled with air, said sealing being accomplished by a suitable deflection or output adjustment.

The electron beam 2 has substantially the shape of a hyperboloid of revolution. It can be deflected and thereby focussed by magnetic fields prior to being guided down towards the workpiece or workpieces. In this case, the electron beam 2 is focussed inside the wire above the workpiece. Afterwards the beam 2 has to be kept narrow until it reaches the workpiece and collides with it.

The beam can be kept focussed inside the above-mentioned hole 3 in wire for a comparatively long distance. The same applies to the inside of the wire, however a little melting of the inside of the wire is unavoidable. Alternatively, focussing coils or other means of establishing suitable magnetic forces for regulating/improving the focussing properties may be arranged around the wire.

Given suitable focussing, optionally fluctuating with time, the electron beam 2 can melt the wire from within while melting the workpiece at the same time. Varying the focussing can result in oscillation of the focal point in the propagation direction of the beam as well as in the plane perpendicular thereto. Therefore quality welding using an electron beam can be achieved with a suitable choice of advance speed for the wire and parameters for the beam 2 without having to place the workpiece in a vacuum chamber during welding.

In the above it has been assumed that the wire melts at the top of the weld. However, it is possible to imagine a situation where the selected inside diameter of the wire together with the propagation of the electron beam down through the wire requires the wire to be melted by the electron beam from the inside prior to reaching the workpiece. In this case it is necessary to choose an advance speed of the wire which is sufficiently high that the wire is not completely melted above the workpiece. This may result in an advance speed of the wire which must not drop below a certain minimum speed.

A variation of the above may involve that two workpieces to be welded are provided with a gap or seam which is slightly wider than the outside diameter of the wire, and the wire being guided down to the bottom of the seam and melted during welding.

This can be performed as sequential welding where a wire piece is guided down into the weld seam, the electron beam is activated and the wire is melted, whereupon the electron beam is deactivated, workpiece and electron gun are moved and a new sequence is started.

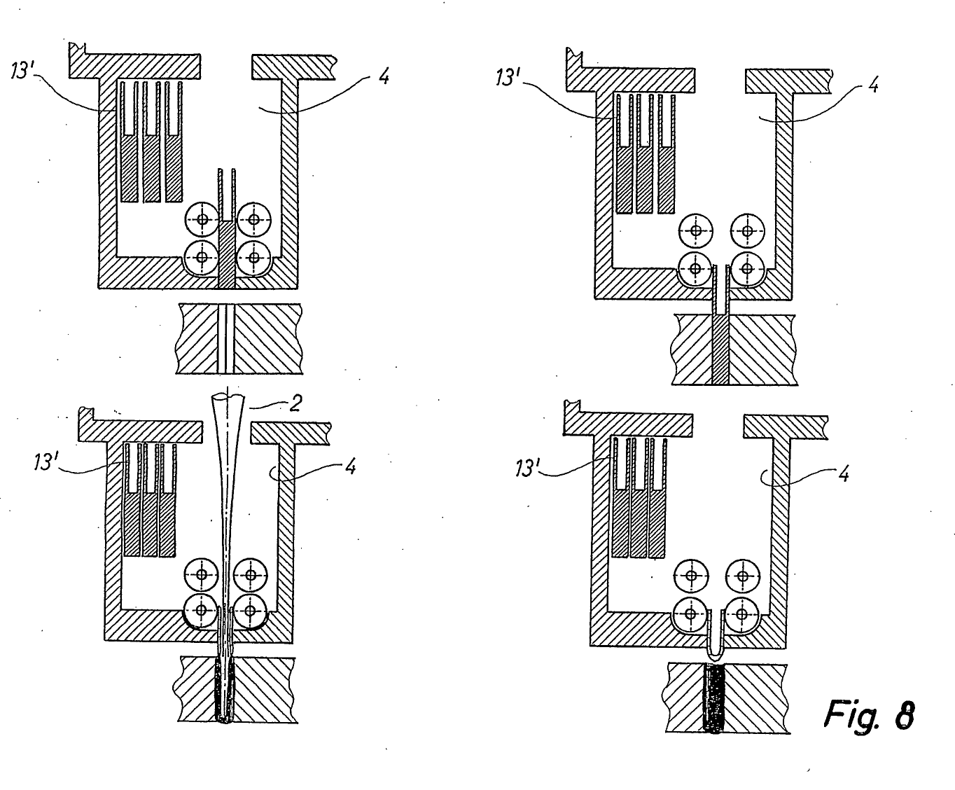

This technique can be carried out using sequentially advanced wire pieces 13′ where the individual wire pieces are not pressed together but only propel each other. At the end of a melting pulse a wire fragment is left, the end of said fragment being closed by means of a finishing pulse. The next wire piece 13′ is then positioned above the wire fragment (inside the vacuum chamber) and pressed a little, so that the fragment of the previous wire piece falls off, whereupon the new wire piece is guided down into the seam, cf. FIG. 8.

The individual wire pieces can advantageously be provided with a solid bottom so that no air can flow in during pressing into the weld seam. In this case it is an advantage to provide the wire pieces with a cross-section which is not necessarily round in order to achieve optimum filling of the weld seam.

Another method to ensure optimum filling of the weld seam is to press the wire piece down during a single electron beam pulse, optionally combined with slow focussing, where the wire piece gradually becomes wider and melts while penetration is reduced.

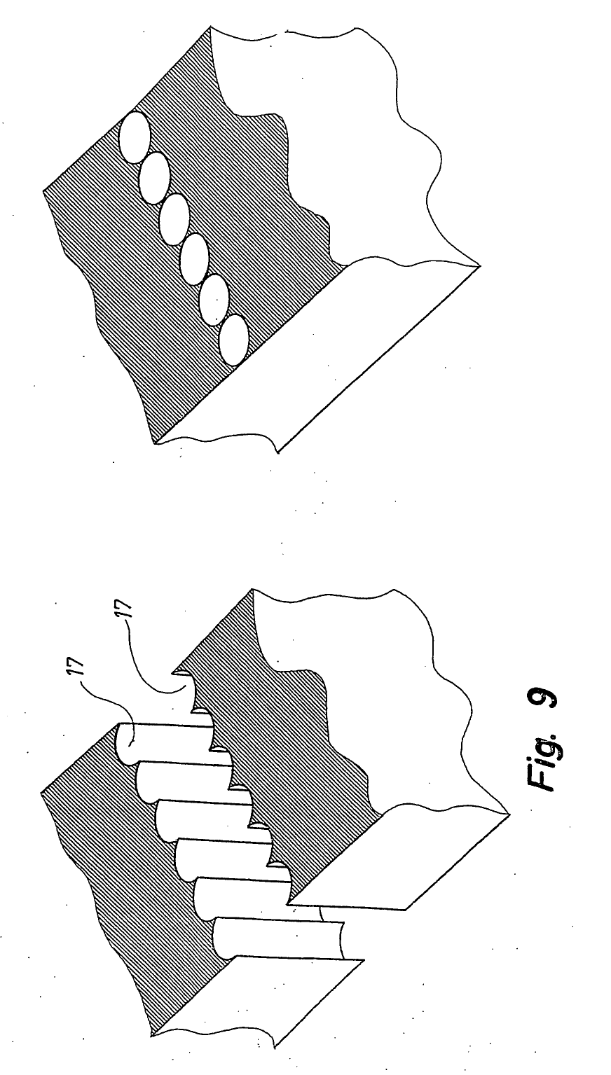

A third method to ensure optimum filling is to prepare the two parts to be welded so that the round wire pieces fit precisely between the two parts. For this purpose each of the two parts can be provided with a number of semicircular millings 17, cf. FIG. 9, opposite each other. This method provides precise, high-quality joints with even very thick workpieces.

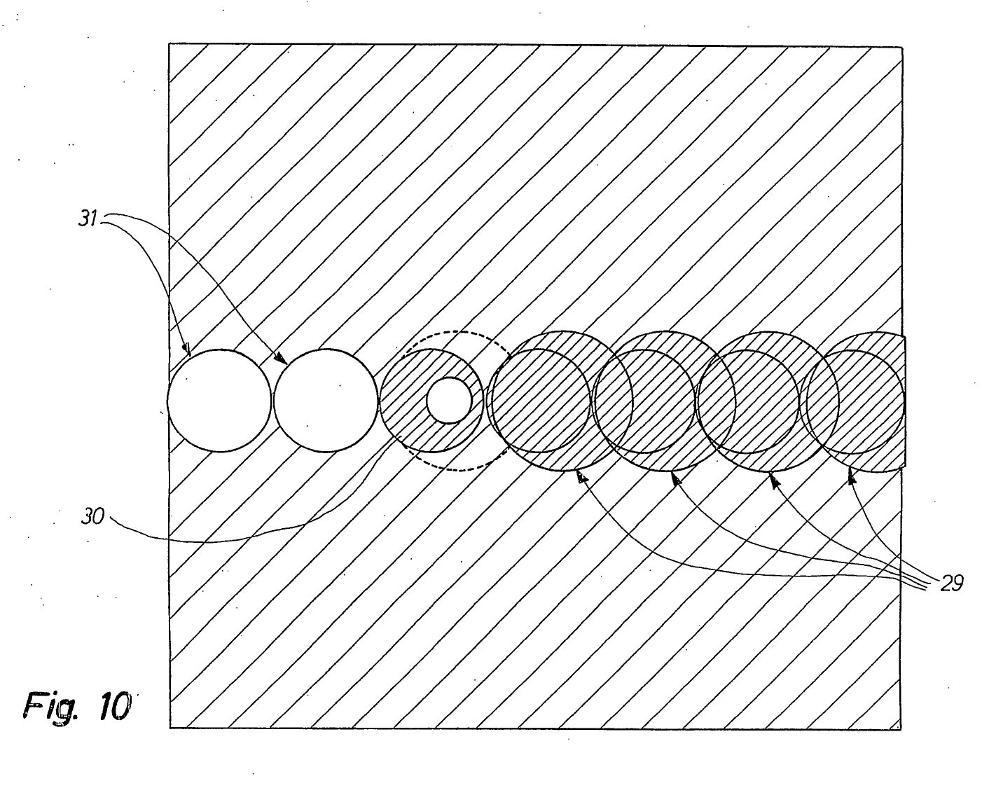

When pressing sequentially advanced wire into the seam (mainly in the case when workpieces have been prepared for a comparatively close fit of wire pieces and workpieces) it is advantageous to melt each wire piece or the workpiece material in such a way that the hole in a given wire piece is not damaged by the previous welding sequence. This means that the wire fragment pointing towards the not yet welded part of the seam must not be melted in this sequence, but in the subsequent one. There are several ways of ensuring this, and reference is made to FIG. 10 showing the joint seen from above. The view shows four sequentially performed welds 29 as well as a wire piece 30 pressed into the next hole between the workpieces. Moreover the figure shows two empty holes 31 between the workpieces. The wire piece 30 is shown with an asymmetrically positioned hole, and the circumference of the melt bath is shown by a dotted line. It is also possible to use symmetrical wire pieces as well as beam oscillation across the welds and behind, i.e. towards the already welded portion, so that the melt zone does not become rotational symmetric.

One variation of the above-described methods is the use of sequentially advanced wire pieces with so large an internal cross-section that the electron beam can pass through a single wire piece substantially unchanged. Then a filler material 19 can be transferred sequentially to the inside of the wire piece, either in the form of short wire fragments with outside diameters smaller than the inside diameter of the wire piece or in powder form. It should be mentioned that the first step in the welding process is to melt the bottom of the first fed wire piece, and powder or wire fragments are first supplied in the following steps.

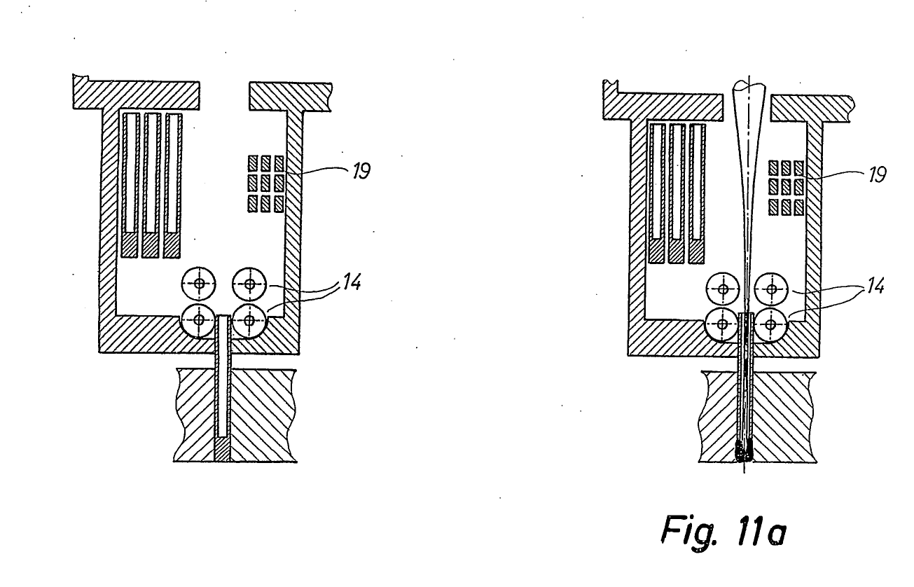

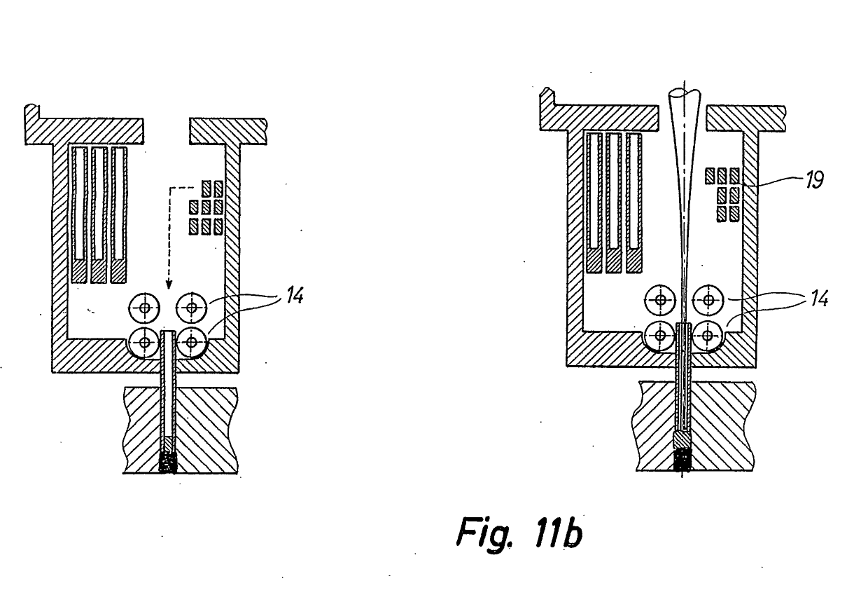

This can e.g. be accomplished in a sequence where a wire piece is pressed down into the weld seam, cf. FIGS. 11a and 11b, and the bottom is melted. Then a small portion of filler material 19 is transferred to the inside of the wire piece, whereupon the filler material is melted. When the filler material 19 is melted, the surrounding tube of the wire piece melts as well, and welding can be performed by means of the bottom part of the wire piece. Then, further filler material 19 is added while the electron beam is temporarily deactivated, and the process is repeated. This sequential process continues, until the entire wire piece is filled and melted together with the workpieces to be welded.

Using this welding method it is also possible to use beam oscillation or a variable beam output during each sequence to achieve a particularly high welding quality.

It is also conceivable to use a hybrid welding method, i.e. a welding method where several energy sources are used for the welding process.

A hybrid welding method can be established in connection with the present invention, if electric current is applied while the wire piece and filler material are advanced. The wire piece must, however, first melt, when it has reached the workpiece, and not between the vacuum chamber and the workpiece, because this will result in a collapse of the electron beam processing. Such extra current application can assist the welding in certain cases.

Alternatively, the beam used can be a laser beam.

The method of electron beam processing can be used for any form of electron beam processing, such as welding, cutting and drilling with an electron beam by means of a filler wire.

FIG. 12 illustrates a method of sequential electron beam processing with deep penetration. Steps 1-5 show schematically a hollow filler wire 41 guided out of the electron beam apparatus and down towards a workpiece 42. In step 1, the filler wire 41 is ready to be sequentially fed. The apparatus is a modified nonvacuum electron beam welder, and this sequence uses vacuum in the electron beam apparatus by evacuating air through the hollow wire 41, as said filler wire being open at one end in the beginning just as in a nonvacuum welder.

In step 2, the electron beam 2 is activated and scatters when it comes in contact with a gas. In this step the electron beam 2 collides with the tip of the wire 41 melting it completely or partially. As a result of a partial vacuum in the wire 41 the latter is constricted until it is closed as shown for step 3. The constriction can be stabilized by pulsing the electron beam 2. After having established contact between this closed wire and the workpiece 42, the electron beam may again be deactivated temporarily, whereupon it is briefly activated again. Thus a cycle is achieved where the wire 41 first solidifies, whereupon the electron beam 2 is now better focussed (as a result of the evacuation of the wire) and melts the wire 41 and the surface of the workpiece 42 with a short pulse of relatively low intensity (and optionally a small rotation of the electron beam). When the beam 2 is deactivated again, the wire 41 and the workpiece 42 are welded together (step 4) over a comparatively wide area. When the electron beam 2 is activated again with a strong pulse directly after solidification, a deep “keyhole” is formed immediately at the end of the wire 41 and the workpiece 42. The keyhole penetrates the workpiece 42, and when it penetrates the bottom, the electron beam 2 may collide with the air below and be scattered. The reason for the optionally relatively broad weld in step 4 is to prevent melt from spreading into the atmosphere at the sides when the electron beam 2 is activated in step 5. Atmospheric pressure can only act on the melt (and thus on the entire melted material), when the melt has flowed out to the border of the initial weld due to heat conduction. This means that the balance between evaporation in the keyhole and pressure from the melt shifts resulting in decreasing penetration depth. Moreover, the part of the wire 41 that has just melted is pressed upwards towards the electron beam apparatus by atmospheric pressure. Then, the electronic beam 2 is deactivated temporarily, whereupon weld and wire solidify. After a relative movement the sequence is repeated (starting with step 3). It is possible for the wire 41 to lose contact with the workpiece 42 with certain combinations of process parameters. Nevertheless the sequence continues unaltered. The shift is comparatively little, the wire 41 is deformed elastically until the electron beam 2 repeats step 3 (where a small amount of heat is generated to create contact between the wire and the workpiece). Now the wire springs forward again, if it has been elastically deformed.

However, the figure illustrates only one embodiment of the present invention. The advance of the wire and the sequential output rate may vary. Moreover, an embodiment is conceivable, where step 1 and step 2 are replaced by wire preparation where prior to start-up the wire end is either mechanically compressed, provided with an end piece or brought into substantially pressure-tight contact with the workpiece. Thus, the demands on the capacity of the vacuum pump are lessened, thereby reducing the costs for the pump apparatus. Also in this case the wire tip must normally be fashioned into the correct shape prior to starting the process, for example by means of the electron beam. Another conceivable embodiment is that the wire never really solidifies, and that the melt is always wider than the contact surface between wire and workpiece. In this case, atmospheric pressure affects the melt, thereby reducing penetration depth. Nevertheless, this process has a better penetration depth for a given welding speed than traditional nonvacuum electron beam welding.

However, it may still be necessary to vary the output cyclically to ensure the correct form of the wire tip.

In another embodiment, there is little or only periodic physical contact between wire and workpiece.

In this case, the process resembles nonvacuum electron beam welding, but with the advantage that the electron beam 2 only collides with a limited amount of air molecules on its path between the wire 41 and the workpiece 42, and therefore beam deflection is considerably less than normal, and the process is thus superior to prior art, especially with smaller welding depths.

This technique combined with a gas nozzle can also be used for electron beam cutting and drilling.

If a gas nozzle is positioned coaxially around the wire 41 or axially displaced behind the wire 41, it can stepwise blow away the melt. In this case the process for cutting or drilling thick workpieces must be predominantly sequential, as described above. After each sequence the workpiece 42 is moved in relation to the electron beam apparatus for such a distance that the next melting starts inside the material, and the melt spreads so far that it breaks through the wall of the existing cutting gap first shortly after the electron beam 2 has penetrated the workpiece. At this moment the keyhole collapses, and the melt is blown out of the gap. Using a gas having an exothermal reaction with the melt, such as oxygen, increases the efficiency of the process.

It is also conceivable that the above-mentioned process options with a continuously melting wire tip and having a more or less good contact with the workpiece can be used for cutting comparatively thin materials. However, this process requires a more careful adjustment of the wire advance and the output modulation so that the wire 41 does not collapse. For cutting, wires with small inside diameters have the advantage that the melt trying to flow into the wire collides with the electron beam 2, thus melting/evaporating the material, and if the beam is of sufficiently high intensity, it slows down the melt or even prevents it form flowing in. If, on the other hand, the inside diameter of the wire is large compared to the electron beam 2, there is space for the melt to flow in next to the electron beam.

Choosing suitable process parameters this technique can also be used for hole drilling.

The means for advancing the filler wire can be the same as previously described in connection with FIGS. 5 and 8.

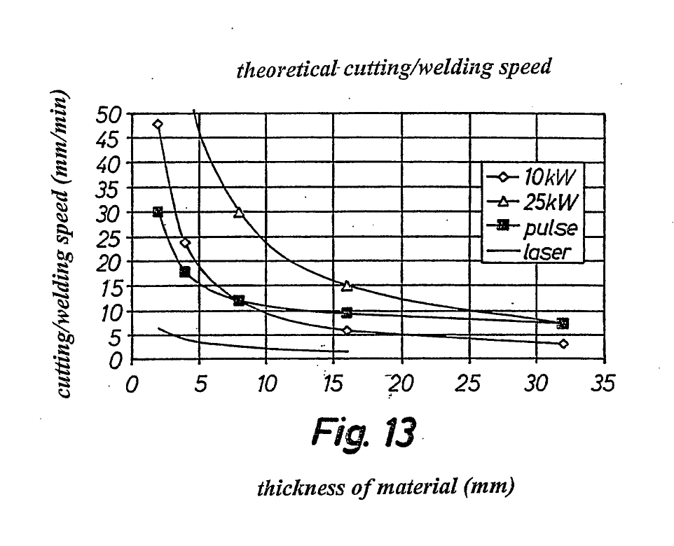

FIG. 13 shows diagrams to illustrate the cutting/welding speed. These diagrams show theoretical process speeds for electron beam cutting compared with cutting speeds obtainable in laser cutting.

The main advantage of using an electron beam for cutting rather than a laser beam is that electron beams can be much stronger than laser beams, on the one hand, because large lasers do not possess sufficiently good focussing properties, and on the other, because in laser welding the penetration of laser beams into workpieces is limited by plasma generation.

The electron beam processing described above can be used to butt welding or resistance butt welding in such a way that the weld is positioned proximate to the gap between the workpieces. As for cutting a thick plate, the electron beam can ensure by broadly pre-welding the wire that the subsequent primary welding pulse deeply penetrates the material so that a deep keyhole is formed in the surrounding melt, said melt spreading radially. At the beginning of the strong pulse there is no connection between the melt and the surrounding atmosphere, and therefore atmospheric pressure does not affect the melt. After the welding pulse has been active for a while the melt spreads so far radially that it reaches the gap between the two workpieces, and the keyhole collapses. However, that does not prevent the melt from spreading further, and by selecting a suitable step interval between welds in relation to the gap geometry, a weld can be obtained. Preferably, this technique makes use of a zigzag advance of the electron beam so that the welds are alternately on one and the other of the two parts to be welded. Using a welding wire with a large diameter and selecting a suitable parameter interval such a zigzag advance can be accomplished with only a simple relative movement of the workpiece and the welding apparatus while the electron beam welds first on one side and then on the other side of the wire by means of suitable deflection.

The beam processing described above is not limited to electron beam processing. Laser beam processing can also be used, in which case a special nozzle/beam configuration is required.

1. Method of electron beam processing of at least one workpiece positioned outside a vacuum chamber (4) in which the electron beam (2) is generated, said method comprising feeding a wire from the vacuum chamber (4) towards the at least one workpiece arranged outside the vacuum chamber (4), wherein the electron beam (2) is generated in the vacuum chamber (4) and is directed towards the at least one workpiece through the wire fed towards the at least one workpiece.

2. Method according to claim 1 wherein the wire is fed from a magazine provided in the vacuum chamber (4).

3. Method according to claim 1 wherein a seal is established around the wire where said wire exits the vacuum chamber (4).

4. Method according to claim 3 wherein the seal is provided by reducing the diameter of the wire by means of pressing or pulling the wire through an output opening of a matrix.

5. Method according to claim 1 wherein the wire is formed using one or more flat wires, said wire or wires being fashioned into a tube inside the vacuum chamber (4).

6. Method according to claim 1 wherein the advance path of the tube inside the vacuum chamber (4) is curved, so that said tube is guided out of the vacuum chamber (4) paraxially to the beam (2) and substantially coaxially therewith, a non-stationary hole (3) being provided in the wire at the place where the wire crosses the path of the electron beam.

7. Method according to claim 1 wherein the wire comprises sequentially advanced tube pieces (13) stored in a magazine, wherefrom they are guided to an ejection system.

8. Method according to claim 7 wherein each tube piece (13) is provided with a bottom (13a) at one end and a recess at one end or both ends.

9. Method according to claim 7 wherein a wire piece is guided down a gap where the workpieces are to be electron beam welded, whereupon the beam (2) is activated and the wire is melted and the electron beam is deactivated.

10. Method according to claim 7 wherein the sequentially advanced wire pieces have so large an internal cross-section that the electron beam (2) can pass through a single wire piece substantially unchanged, whereupon a filler material is transferred to each wire piece, either in the form of short wire fragments with outside diameters smaller than the inside diameter of the wire piece or in powder form.

11. Method according to claim 1 and used in connection with a hybrid electron beam welding method, where electric current is applied to the wire.

12. Method according to claim 1 wherein a variable beam output is employed during processing.

13. Method according to claim 1 wherein beam oscillation is employed during processing.

14. Method according to claim 1 wherein a processing sequence is employed where the wire is fed in a first step, the electron beam is activated and melts the tip of the wire in a second step, the tip of the wire is constricted in a third step and the wire and the workpiece are then welded together in a fourth step, whereupon an opening is formed through the end of the wire tip and the workpiece by supplying a strong electron beam in a fifth step.

15. Method according to claim 1 wherein prior to start-up the wire end is either mechanically compressed, provided with an end piece or brought into substantially pressure-tight contact with the workpiece, the tip of the wire is constricted and the wire and the workpiece are then molded together, whereupon an opening is formed through the end of the wire tip and the workpiece by applying a strong electron beam.

16. Method according to claim 1 wherein the processing is selected from the group consisting of welding, cutting and drilling.

17. Method according to claim 1 wherein the wire is hollow.
